(19) United States
(12) Patent Application Publication
(10) Pub. No.: US 2006/0090012 A1
(43) Pub. Date: Apr. 27, 2006

(54) Modular SDD (scalable device driver) framework

(76) Inventors: Linden Cornett, Portland, OR (US); Avraham Mualem, Jerusalem (IL); Zohar Levy, Modiin (IL); Michael A. Bacon, Banks, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/971,498

(22) Filed: Oct. 22, 2004

(51) Int. Cl. G06F 15/16

(52) U.S. Cl. 709/250

(57) ABSTRACT

In one embodiment, a method is provided. The method of this embodiment provides in response to receiving one or more packets from one or more base drivers, indicating the one or more packets to one or more protocol offload modules in a system implementing a scalable device driver (SDD), handling protocol offloading at one or more protocol offload modules, and indicating the one or more packets to the SDD to perform limited SDD processing.

### FIELD

Embodiments of this invention relate to a modular SDD (Scalable Device Driver) framework.

### BACKGROUND

The Network Device Interface Specification (hereinafter “NDIS”) is a Microsoft® Windows® device driver that enables a single network adapter, such as a NIC (network interface card), to support multiple network protocols, or that enables multiple network adapters to support multiple network protocols. The current version of NDIS is NDIS 5.1, and is available from Microsoft® Corporation of Redmond, Wash. In NDIS, when a protocol driver has a packet to transmit, it may call a function exposed by NDIS. NDIS may pass the packet to a port driver by calling a function exposed by the port driver. The port driver may then forward the packet to the network adapter. Likewise, when a network adapter receives a packet, it may call NDIS. NDIS may notify the network adapter's port driver by calling the appropriate function. The port driver may set up the transfer of data from the network adapter and indicate the presence of the received packet to the protocol driver.

NDIS is an example of a scalable device driver (hereinafter “SDD”). A “scalable device driver” refers to a device driver that can support multiple network protocols on a single network adapter and/or that can enable multiple network adapters to support multiple network protocols. However, since known SDD's may not provide a modular architecture in which functions may be performed by specialized modules rather than a single module, portability and reuse of SDD modules across different hardware platforms may present challenges.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a system according to one embodiment.

FIG. 2 is a block diagram illustrating a modules suite according to one embodiment.

FIG. 3 is a block diagram illustrating a modules suite according to another embodiment.

FIG. 4 is a flowchart illustrating a method according to one embodiment.

FIG. 5 is a flowchart illustrating a method according to another embodiment.

### DETAILED DESCRIPTION

Examples described below are for illustrative purposes only, and are in no way intended to limit embodiments of the invention. Thus, where examples may be described in detail, or where a list of examples may be provided, it should be understood that the examples are not to be construed as exhaustive, and do not limit embodiments of the invention to the examples described and/or illustrated.

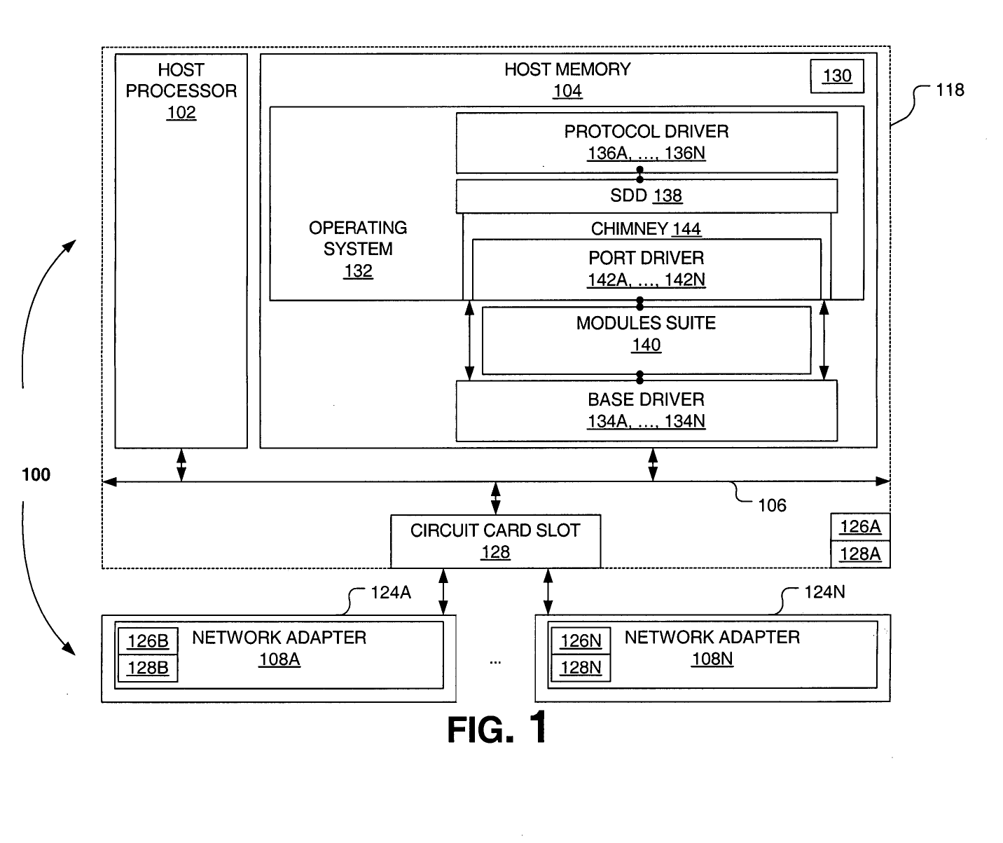

FIG. 1 illustrates a system in one embodiment. System 100 may comprise host processor 102, host memory 104, bus 106, and one or more network adapters 108A, . . . , 108N. System 100 may comprise more than one, and other types of processors, memories, and buses; however, those illustrated are described for simplicity of discussion. Host processor 102, host memory 104, and bus 106, may be comprised in a single circuit board, such as, for example, a system motherboard 118. Rather than reside on circuit cards 124A, . . . , 128N, one or more network adapters 108A, . . . , 108N may instead be comprised on system motherboard 118.

Host processor 102 may comprise, for example, an Intel® Pentium® microprocessor that is commercially available from the Assignee of the subject application. Of course, alternatively, host processor 102 may comprise another type of microprocessor, such as, for example, a microprocessor that is manufactured and/or commercially available from a source other than the Assignee of the subject application, without departing from this embodiment.

Bus 106 may comprise a bus that complies with the Peripheral Component Interconnect (PCI) Local Bus Specification, Revision 2.2, Dec. 18, 1998 available from the PCI Special Interest Group, Portland, Oreg., U.S.A. (hereinafter referred to as a “PCI bus”). Alternatively, for example, bus 106 may comprise a bus that complies with the PCI Express Base Specification, Revision 1.0a, Apr. 15, 2003 available from the PCI Special Interest Group (hereinafter referred to as a “PCI Express bus”). Bus 106 may comprise other types and configurations of bus systems.

Host memory 104 may store machine-executable instructions 130 that are capable of being executed, and/or data capable of being accessed, operated upon, and/or manipulated by circuitry, such as circuitry 126A, 126B, . . . , 126N. Host memory 104 may, for example, comprise read only, mass storage, random access computer-accessible memory, and/or one or more other types of machine-accessible memories. The execution of program instructions 130 and/or the accessing, operation upon, and/or manipulation of this data by circuitry 126A, 126B, . . . , 126N for example, may result in, for example, system 100 and/or circuitry 126A, 126B, . . . , 126N carrying out some or all of the operations described herein.

Each network adapter 108A, . . . , 108N and associated circuitry 126B, . . . , 126N may be comprised in a circuit card 124A, . . . , 124N that may be inserted into a circuit card slot 128. When circuit card 124A, . . . , 124N is inserted into circuit card slot 128, PCI bus connector (not shown) on circuit card slot 128 may become electrically and mechanically coupled to PCI bus connector (not shown) on circuit card 124A, . . . , 124N. When these PCI bus connectors are so coupled to each other, circuitry 126B, . . . , 126N in circuit card 124A, . . . , 124N may become electrically coupled to bus 106. When circuitry 126B is electrically coupled to bus 106, host processor 102 may exchange data and/or commands with circuitry 126B, . . . , 126N via bus 106 that may permit host processor 102 to control and/or monitor the operation of circuitry 126B, . . . , 126N.

Circuitry 126A, 126B, . . . , 126N may comprise one or more circuits to perform one or more operations described herein as being performed by base driver 134A, . . . , 134N, network adapter 108A, . . . , 108N, or system 100. In described embodiments, operations said to be performed by base driver 134A, . . . , 134N or by network adapter 108A, . . . , 108N should be understood as capable of being generally performed by system 100 without departing from embodiments of the invention. Circuitry 126A, 126B, . . . , 126N may be hardwired to perform the one or more operations. For example, circuitry 126A, 126B, . . . , 126N may comprise one or more digital circuits, one or more analog circuits, one or more state machines, programmable circuitry, and/or one or more ASIC's (Application-Specific Integrated Circuits). Alternatively, and/or additionally, these operations may be embodied in programs that may perform functions described below by utilizing components of system 100 described above. For example, circuitry 126A, 126B, . . . , 126N may execute machine-executable instructions 130 to perform these operations. Alternatively, circuitry 126A, 126B, . . . , 126N may comprise computer-readable memory 128A, 128B, . . . , 126N having read only and/or random access memory that may store program instructions, similar to machine-executable instructions 130.

Host memory 104 may comprise one or more base drivers 134A, . . . , 134N each corresponding to one of one or more network adapters 108A, . . . , 108N. Host memory 104 may additionally comprise modules suite 140, and operating system 132. Each base driver 134A, . . . , 134N may control one of one or more network adapters 108A, . . . , 108N by initializing one or more network adapters 108A, . . . , 108N, and allocating one or more buffers for receiving one or more packets, for example. Network adapter 108A, . . . , 108N may comprise a NIC, and base driver 134A, . . . , 134N may comprise a NIC driver, for examples. Modules suite 140 may comprise one or more modules and interfaces to facilitate modularized communication between base driver 134A, . . . , 134N and an SDD 138 that supports chimney 144 and port driver 142A, . . . , 142N functions.

Operating system 132 may comprise one or more protocol drivers 136A, . . . , 136N, and SDD 138. Each protocol driver 136A, . . . , 136N may be part of operating system 132, and may implement a network protocol, such as TCP/IP (Transport Control Protocol/Internet Protocol). SDD 138 may include chimney 144 and one or more port drivers 142A, . . . , 142N. “Chimney” refers to network protocol offload capabilities that offload some portion of a network protocol stack to one or more devices. Devices may comprise, for example, network adapters 108A, . . . , 108N, but embodiments of the invention are not limited by this example. Each port driver 142A, . . . , 142N may support a network adapter 108A, . . . , 108N within SDD 138, and may expose one or more functions by which SDD 138 may call it, and may call one or more functions exposed by SDD 138 for transmitting and receiving packets within SDD 138.

In one embodiment, operating system 132 may comprise Microsoft® Windows®, and chimney 144 may comprise TCP Chimney functions as part of a new version of Microsoft® Windows® currently known the “Scalable Networking Pack” for Windows Server 2003. TCP Chimney is described in “Scalable Networking: Network Protocol Offload—Introducing TCP Chimney”, Apr. 9, 2004, available from Microsoft® Corporation. SDD 138 may comprise NDIS 5.2 or 6.0, for example, and port driver 142A, . . . , 142N may comprise a miniport driver as described in NDIS 5.2 or 6.0, for example. While these versions have not been released, the NDIS 5.2 and NDIS 6.0 documentation are available from Microsoft® Corporation.

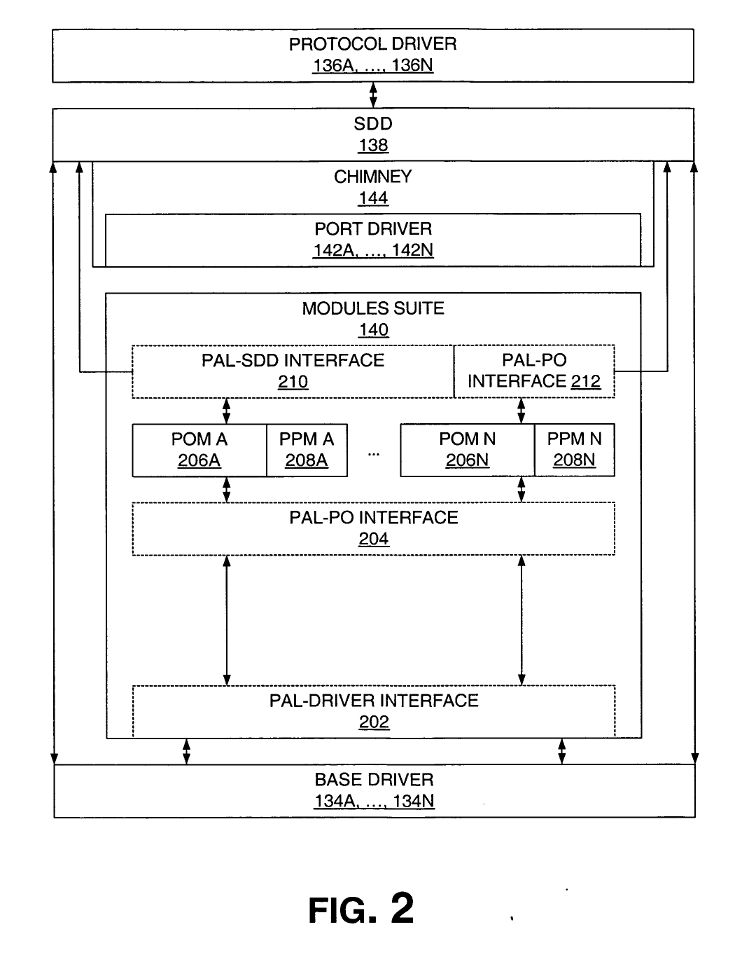

FIG. 2 is a block diagram illustrating modules suite 140 in one embodiment. As illustrated in FIG. 2, modules suite 140 may comprise various modules, including at least one protocol offload module (labeled “POM”) 206A, . . . , 206N, and a corresponding number of protocol processing modules (labeled “PPM”) 208A, . . . , 208N. Protocol offload module 206A, . . . , 206N may interact with chimney 144, and protocol processing module 208A, . . . , 208N. Modules suite 140 may additionally comprise at least one PAL (Port Abstraction Layer) interface, including PAL-driver interface 202, PAL-protocol offload (labeled “PAL-PO”) interface 204, PAL-SDD interface 210, and PAL-protocol offload interface 212. PAL interfaces may perform one or more functions of port drivers 142A, . . . , 142N throughout one or more layers of modules suite 140 by abstracting those functions into modularized modules. The modularization provides the ability to add and omit functionality as needed without necessarily having to rewrite an entire module. PAL interfaces may perform additional functions not performed by port drivers 142A, . . . , 142N.

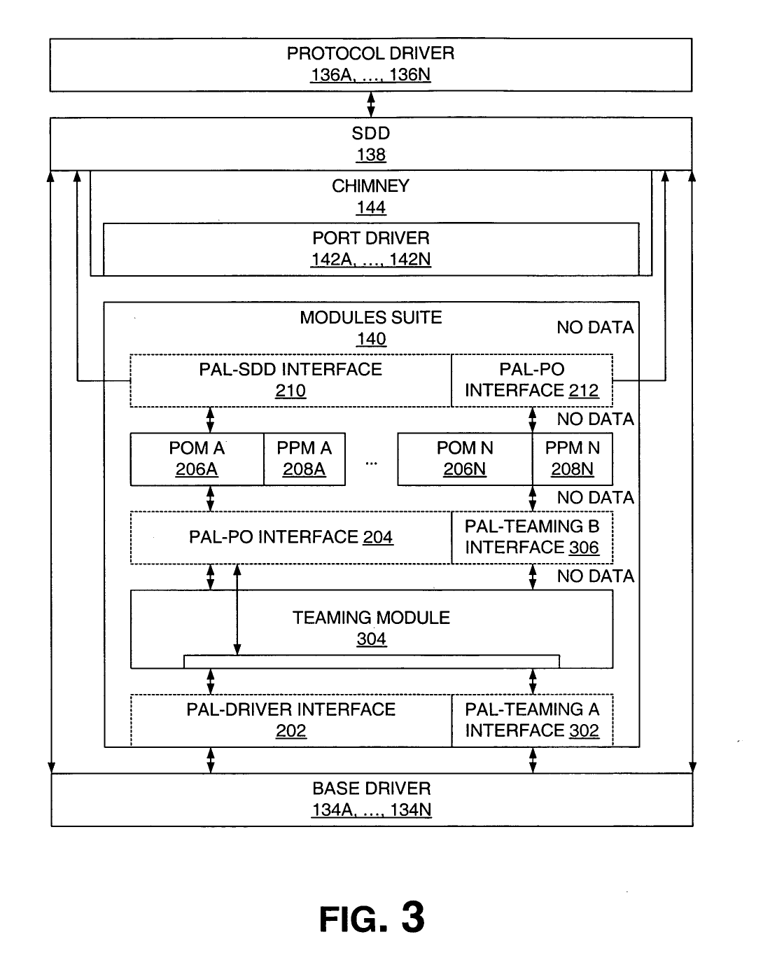

FIG. 3 is a block diagram illustrating modules suite 140 in another embodiment. In addition to PAL-driver interface 202, PAL-protocol offload interface 204, PAL-SDD interface 210, PAL-protocol offload interface 212, protocol offload module A-N 206A, . . . , 206N, and protocol processing module A-N 208A, . . . , 208N, modules suite 140 may comprise PAL-teaming interface A 302, PAL-teaming interface B 306, and teaming module 304. PAL-teaming interface A and B 302, 304 may be utilized to support teaming. As used herein, “teaming” refers to a capability of a system to support failover and/or load balancing where there may be multiple devices, or multiple ports of a device, for example. “Failover” refers to an ability of a system to handle the failure of one or more hardware components. For example, if any one or more network adapters 108A, . . . , 108N fails, functionality of the one or more failed network adapters 108A, . . . , 108N may be delegated to another network adapter 108A, . . . , 108N. “Load balancing” refers to an ability of a system to distribute activity evenly so that no single hardware component, such as network adapter 108A, . . . , 108N, is overwhelmed with activity.

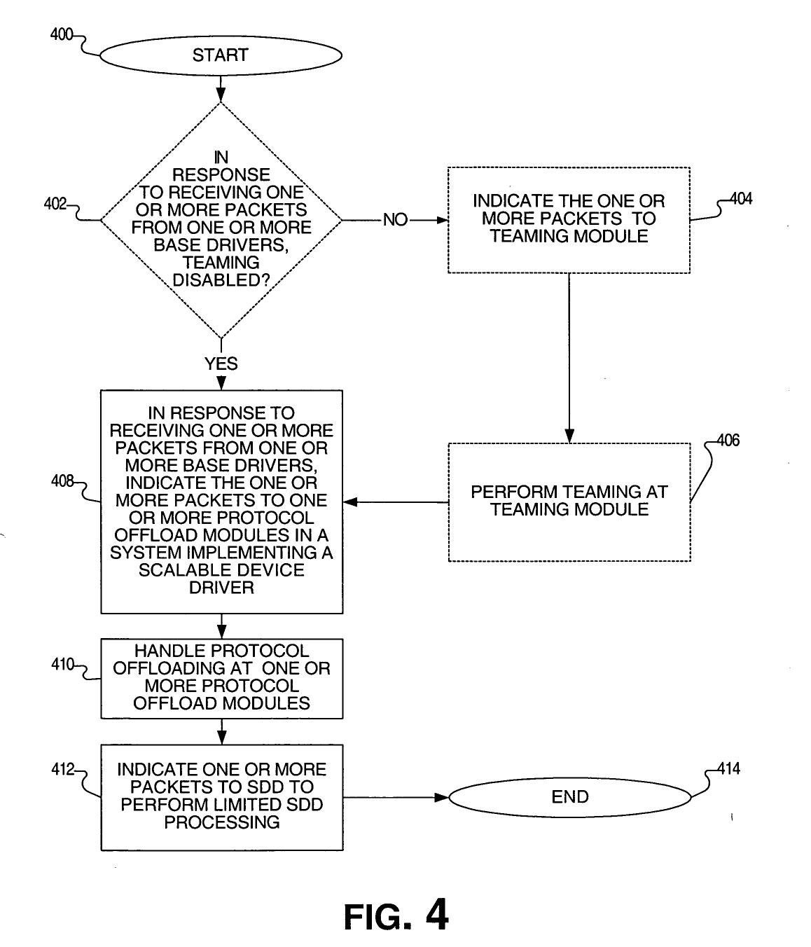

A method according to one embodiment is illustrated in the flowchart of FIG. 4 with reference to FIGS. 1, 2, and 3. The method begins at block 400, and continues to block 402 where in response to receiving one or more packets from one or more base drivers 134A, . . . , 134N, it may be determined if teaming is enabled. In one embodiment, PAL-driver interface 202 may perform this function. If at block 402 it is determined that teaming is not disabled (i.e., enabled), the method may continue to block 404. If at block 402 it is determined that teaming is disabled, the method may continue to block 408.

At block 404, one or more packets may be indicated to teaming module 304. In one embodiment, PAL-driver interface 202 may perform this function. In one embodiment, packets may be indicated via one or more interfaces. For example, one or more interfaces may comprise PAL-teaming A interface 306. The method may continue to block 406.

At block 406, teaming may be performed at teaming module 304. When receiving one or more packets on network adapter 108A, . . . , 108N, teaming may comprise aggregating one or more packets from buffers posted by one or more base drivers 134A, . . . , 134N. The method may continue to block 408.

In one embodiment, the teaming operations described in blocks 402, 404, and 406 may be omitted. In this embodiment, the method may begin at block 400 and continue to block 408 where one or more packets may be indicated to one or more protocol offload modules in a system implementing a scalable device driver in response to receiving one or more packets from one or more base drivers 134A, . . . , 134N. The method may continue to block 410.

At block 408, one or more packets may be indicated to one or more protocol offload modules 206A, . . . , 206N. If teaming is disabled, PAL-driver 202 may perform this operation. If teaming is enabled, PAL-teaming interface 306 may perform this operation. In one embodiment, one or more packets may be indicated via one or more interfaces. Furthermore, one or more interfaces may comprise PAL-protocol offload interface 204. The method may continue to block 410.

At block 410, one or more protocol offload modules 206A, . . . , 206N may handle protocol offloading. Protocol offloading may comprise interacting with chimney 144 to implement chimney 144 functions, calling protocol processing module A-N 208A, . . . , 208N to perform protocol processing, and interacting with base driver 134A, . . . , 134N to determine the number of receive queues that are supported in hardware. In one embodiment, this architecture may be implemented in a Microsoft® Windows environment, where an ISR (Interrupt Service Routine) may run to acknowledge an interrupt. In this embodiment, a DPC (Deferred Procedure Call) may run to process the interrupt events, and protocol offload module 206A, . . . , 206N may need to know how many DPCs are running.

Chimney 144 functions may comprise advertising chimney 144 capabilities, such as the number of connections and the supported IP version, and implementing chimney APIs (application program interface) that may be used to implement chimney-specific entry points including offloading a connection, sending offloaded data, and posting receive buffers, for example. For example, protocol offload module 206A, . . . , 206N may advertise its capabilities if teaming is disabled.

Protocol processing may comprise interacting with base driver 134A, . . . , 134N to transmit and receive packets from one or more buffers, and interacting with protocol offload module 206A, . . . , 206N to perform offload transmits and receives. In one embodiment, protocol processing may be performed by a TCP-A (Transport Control Protocol-Accelerated) driver. A TCP-A driver may perform optimized TCP packet processing for at least one of the one or more packets, including, for example, retrieving headers from buffers, parsing the headers, and performing TCP protocol compliance. A TCP-A driver may additionally perform one or more operations that result in a data movement module, such as a DMA (direct memory access) engine, placing one or more corresponding payloads of packets into a read buffer. Furthermore, TCP-A may overlap these operations with protocol processing to further optimize TCP processing. TQP-A drivers and processing are further described in U.S. patent application Ser. No. 10/815,895, entitled “Accelerated TCP (Transport Control Protocol) Stack Processing”, filed on Mar. 31, 2004. Protocol processing is not limited to operations performed by TCP-A drivers.

If teaming is disabled, PAL-protocol offload interface 204 may indicate one or more packets to a plurality of protocol offload modules A-N 206A, . . . , 206N. If teaming is enabled, or if there is only one instance of a base driver 134A, . . . , 134N, PAL-protocol offload interface 204 may indicate one or more packets to a single protocol offload module A-N 206A, . . . , 206N.

At block 412, one or more packets may be indicated to SDD 138 to perform limited SDD processing. Limited SDD processing may include calling the host protocol stack via protocol driver 136A, . . . , 136N to complete Chimney-related requests (e.g., sending offloaded data, and completing a posted receive buffer). In one embodiment, PAL-SDD interface 210 may indicate the one or more packets to SDD 138.

Although PAL-protocol offload interface 212 and PAL-SDD interface 210 are illustrated as separate interfaces in FIG. 2, PAL-protocol offload interface 212 and PAL-SDD interface 210 may instead be a single interface, where protocol offload module A-N 206A, . . . , 208N may indicate one or more packets to the single interface, which may then indicate the one or more packets to SDD 138. The modularization of interfaces PAL-protocol offload interface 212 and PAL-SDD interface 210 may be useful where additional modules and/or interfaces may be added, for example.

The method ends at block 414.

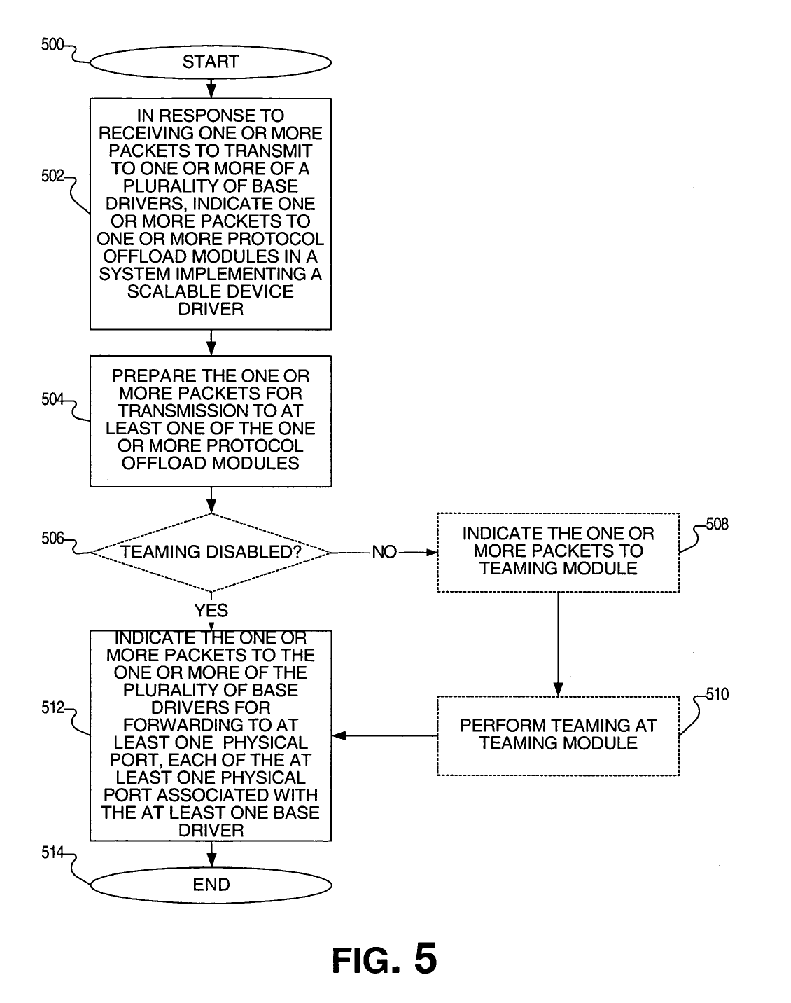

FIG. 5 illustrates a method according to another embodiment. The method begins at block 500 and continues to block 502 where in response to protocol driver 136A, . . . , 136N receiving one or more packets to transmit to one or more of a plurality of base drivers 134A, . . . , 134N, indicating the one or more packets to one or more protocol offload modules A-N 206A, . . . , 206N in a system implementing an SDD 138. In one embodiment, the one or more packets may be indicated via one or more interfaces. One or more interfaces may comprise, for example, PAL-SDD interface 210 and/or PAL-protocol offload interface 212.

At block 504, at least one of the protocol offload modules 206A may prepare the one or more packets for transmission to at least one of the one or more protocol offload modules. This may comprise creating headers for the packets, and assembling the packets, for example.

At block 506, it may be determined if teaming is disabled. In one embodiment, PAL-protocol offload interface 204 may perform this function. If at block 506, it is determined that teaming is disabled, the method may continue to block 512. Otherwise, the method may continue to block 508.

At block 508, one or more packets may be indicated to teaming module 304. In one embodiments packets may be indicated via one or more interfaces. Furthermore, one or more interfaces may comprise PAL-protocol offload interface 204 and/or PAL-teaming interface 306. The method may continue to block 510.

At block 510, teaming may be performed at teaming module 304. When transmitting one or more packets to network adapter 108A, . . . , 108N, teaming may comprise determining which instance of base driver 134A, . . . , 134N to use. For example, teaming module 304 may use an algorithm that sends packets based on IP addresses and/or port information. In one embodiment, one or more packets may be indicated to teaming module 304 via one or more interfaces. One or more interfaces may comprise, for example, PAL-teaming interface A 302. The method may continue to block 512

In one embodiment, the teaming operations described in blocks 506, 508, and 510 may be omitted. In this embodiment, the method may begin at block 500 and continue to block 502 as described above, 504 as described above, and continue to block 512.

At block 512, the one or more packets may be indicated to the one or more plurality of base drivers for forwarding to at least one physical port, each of the at least one physical ports associated with the at least one base driver 134A, . . . , 134N. The method may continue to block 514.

The method ends at block 514.

### CONCLUSION

Therefore, in one embodiment, a method may comprise in response to receiving one or more packets from one or more base drivers, indicating the one or more packets to one or more protocol offload modules in a system implementing a scalable device driver (SDD), handling protocol offloading at one or more protocol offload modules, and indicating the one or more packets to the SDD to perform limited SDD processing.

Embodiments of the invention may enable reuse of the modules and interfaces on different hardware platforms by modularizing processing into defined modules and interfaces. Also, the division of responsibilities between the protocol offloading module and the protocol processing module allows specific network protocol processing stack orders to be easily modified. Furthermore, a teaming module may enable load balancing and failover support in a layer within the framework so that that chimney portion of the scalable device driver need not be aware of the physical devices being supported.

In the foregoing specification, the invention has been described with reference to specific embodiments thereof. It will, however, be evident that various modifications and changes may be made to these embodiments without departing therefrom. The specification and drawings are, accordingly, to be regarded in an illustrative rather than a restrictive sense.

What is claimed is:

1. A method comprising:
in response to receiving one or more packets from one or more base drivers, indicating the one or more packets to one or more protocol offload modules in a system implementing a scalable device driver (SDD);
handling protocol offloading at one or more protocol offload modules; and
indicating the one or more packets to the SDD to perform limited SDD processing.

2. The method of claim 1, wherein said indicating the one or more packets to one or more protocol offload modules comprises indicating the one or more packets to the one or more protocol offload modules via one or more interfaces.

3. The method of claim 2, wherein said indicating the one or more packets to the SDD to perform limited SDD processing comprises indicating the one or more packets to the one or more protocol offload modules via one or more interfaces.

4. The method of claim 1, additionally comprising:
determining if teaming is disabled in response to said receiving one or more packets from one or more base drivers; and
if teaming is not disabled:
indicating the one or more packets to a teaming module; and
performing teaming at the teaming module.

5. The method of claim 1, wherein the SDD conforms to NDIS (Network Device Interface Specification).

6. The method of claim 5, wherein the protocol offload module communicates with a TCP (Transport Control Protocol) Chimney module of NDIS.

7. The method of claim 1, wherein said handling protocol offloading at one or more protocol offload modules comprises calling a protocol processing module to perform protocol processing.

8. The method of claim 8, wherein protocol processing is performed by a TCP-A (Transport Control Protocol-Accelerated) driver.

9. A method comprising:
in response to receiving one or more packets to transmit to one or more of a plurality of base drivers, indicating the one or more packets to one or more protocol offload modules in a system implementing a scalable device driver (SDD);
preparing the one or more packets for transmission to at least one or more of the one or more protocol offload modules; and
indicating the one or more packets to the one or more of the plurality of base drivers for forwarding to at least one physical port, each physical port associated with one of the one or more of the plurality of base drivers.

10. The method of claim 9, additionally comprising:
determining if teaming is disabled in response to said receiving one or more packets from one or more base drivers; and
if teaming is not disabled:
indicating the one or more packets to a teaming module; and
performing teaming at the teaming module.

11. The method of claim 9, wherein the SDD conforms to NDIS (Network Device Interface Specification).

12. The method of claim 11, wherein the protocol offload module communicates with a TCP (Transport Control Protocol) Chimney module of NDIS.

13. The method of claim 9, wherein said handling protocol offloading at one or more protocol offload modules comprises calling a protocol processing module to perform protocol processing.

14. An apparatus comprising:
circuitry to:
in response to receiving one or more packets from one or more base drivers, indicate the one or more packets to one or more protocol offload modules in a system implementing a scalable device driver (SDD);
handle protocol offloading at one or more protocol offload modules; and
indicate the one or more packets to the SDD to perform limited SDD processing.

15. The apparatus of claim 14, additionally comprising circuitry to:
determine if teaming is disabled in response to said receiving one or more packets from one or more base drivers; and
if teaming is not disabled:
indicate the one or more packets to a teaming module; and
perform teaming at the teaming module.

16. The apparatus of claim 14, wherein the SDD conforms to NDIS (Network Device Interface Specification).

17. The apparatus of claim 14, wherein said handling protocol offloading at one or more protocol offload modules comprises calling a protocol processing module to perform protocol processing.

18. The apparatus of claim 17, wherein protocol processing is performed by a TCP-A (Transport Control Protocol-Accelerated) driver.

19. A system comprising:
a circuit board having a circuit card slot;
a network card coupled to the circuit board via the circuit card slot; and
a memory having circuitry to process one or more packets to indicate to the network card, the circuitry to process the one or more packets by:
in response to receiving one or more packets from one or more base drivers, indicating the one or more packets to one or more protocol offload modules in a system implementing a scalable device driver (SDD);
handling protocol offloading at one or more protocol offload modules; and
indicating the one or more packets to the SDD to perform limited SDD processing.

20. The system of claim 19, additionally comprising:
determining if teaming is disabled in response to said receiving one or more packets from one or more base drivers; and
if teaming is not disabled:
indicating the one or more packets to a teaming module; and
performing teaming at the teaming module.

21. The system of claim 19, wherein the SDD conforms to NDIS (Network Device Interface Specification).

22. The system of claim 21, wherein the protocol offload module communicates with a TCP (Transport Control Protocol) Chimney module of NDIS.

23. The system of claim 19, wherein said handling protocol offloading at one or more protocol offload modules comprises calling a protocol processing module to perform protocol processing.

24. An article of manufacture comprising a machine-readable medium having stored thereon instructions, the instructions when executed by a machine, result in the following:
in response to receiving one or more packets from one or more base drivers, indicating the one or more packets to one or more protocol offload modules in a system implementing a scalable device driver (SDD);
handling protocol offloading at one or more protocol offload modules; and
indicating the one or more packets to the SDD to perform limited SDD processing.

25. The article of manufacture of claim 24, wherein said indicating the one or more packets to the SDD to perform limited SDD processing comprises indicating the one or more packets to the one or more protocol offload modules via one or more interfaces.

26. The article of manufacture of claim 24, additionally comprising:
determining if teaming is disabled in response to said receiving one or more packets from one or more base drivers; and
if teaming is not disabled:
indicating the one or more packets to a teaming module; and
performing teaming at the teaming module.

27. The article of manufacture of claim 24, wherein the SDD conforms to NDIS (Network Device Interface Specification).

28. The article of manufacture of claim 27, wherein the protocol offload module communicates with a TCP (Transport Control Protocol) Chimney module of NDIS.

29. The article of manufacture of claim 24, wherein said handling protocol offloading at one or more protocol offload modules comprises calling a protocol processing module to perform protocol processing.

30. The article of manufacture of claim 29, wherein protocol processing is performed by a TCP-A (Transport Control Protocol-Accelerated) driver.
